(19) United States
(12) Patent Application Publication
(10) Pub. No.: US 2025/0292432 A1
(43) Pub. Date: Sep. 18, 2025

(54) IMAGE GENERATION APPARATUS, IMAGE CUTTING METHOD, AND RECORDING MEDIUM

(71) Applicant: NEC Corporation, Tokyo (JP)

(72) Inventors: Hiroaki HAMADA, Tokyo (JP); Tomoko MARUYAMA, Tokyo (JP); Kazuhisa TAKANO, Tokyo (JP)

(73) Assignee: NEC Corporation, Tokyo (JP)

(21) Appl. No.: 18/991,925

(22) Filed: Dec. 23, 2024

(30) Foreign Application Priority Data
Mar. 13, 2024 (JP) 2024-038585

(51) Int. Cl. G06T 7/73; G06T 11/20; G06V 10/26

(52) U.S. Cl. CPC G06T 7/74; G06T 11/206; G06V 10/26; G06T 2207/10028

(57) ABSTRACT

An image generation apparatus includes at least one memory configured to store instructions; and at least one processor configured to execute the instructions to: acquire a synthetic aperture radar (SAR) image; detect an object included in the SAR image; determine a size of a cut-out image corresponding to the object; and generate a cut-out image obtained by cutting out an image having the determined size from the SAR image in such a way that a position of the object in the cut-out image is random.

This application is based upon and claims the benefit of priority from Japanese Patent Application No. 2024-038585, filed on Mar. 13, 2024, the disclosure of which is incorporated herein in its entirety by reference.

### TECHNICAL FIELD

The present disclosure relates to an image generation apparatus, an image cutting method, and a program.

### BACKGROUND ART

When generating training data of a synthetic aperture radar (SAR) image, since a data size of the SAR image is large, the SAR image may be cut out at a predetermined size.

Reference Literature 1 (JP 2023-163692 A) describes cutting of an image including an object image from an image obtained as a result of imaging by a synthetic-aperture radar.

### SUMMARY

An object of the present disclosure is to provide an image generation apparatus and the like capable of reducing an influence of a position of an object in a cut-out image that is cut out from an SAR image.

An image generation apparatus according to one aspect of the present disclosure includes at least one memory configured to store instructions; and at least one processor configured to execute the instructions to: acquire a SAR image; detect an object included in the SAR image; determine a size of a cut-out image corresponding to the object; and generate a cut-out image obtained by cutting out an image having the determined size from the SAR image in such a way that a position of the object in the cut-out image is random.

An image cutting method according to another aspect of the present disclosure includes acquiring an SAR image, detecting an object included in the SAR image, determining a size of the cut-out image corresponding to the object, and generating the cut-out image obtained by cutting out an image having the determined size from the SAR image in such a way that a position of the object in the cut-out image is random.

A program according to still another aspect of the present disclosure causes a computer to execute processing of acquiring an SAR image, detecting an object included in the SAR image, determining a size of the cut-out image corresponding to the object, and generating the cut-out image obtained by cutting out an image having the determined size from the SAR image in such a way that a position of the object in the cut-out image is random.

The program may be stored in a non-transitory computer-readable recording medium.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating an example of a configuration of an image generation apparatus;

FIG. 2A is a view illustrating an example of an SAR image;

FIG. 2B is a view illustrating an example of an SAR image including a detection result;

FIG. 2C is a view illustrating an example of an SAR image showing a cut-out range;

FIG. 2D is a view illustrating an example of the cut-out image;

FIG. 3A is a view illustrating an example of a cut-out range of an SAR image;

FIG. 3B is a view illustrating an example of a cut-out range of the SAR image;

FIG. 3C is a view illustrating an example of a cut-out range of the SAR image;

FIG. 4 is a flowchart illustrating an operation of the image generation apparatus;

FIG. 5 is a block diagram illustrating an example of a configuration of an image generation apparatus;

FIG. 6 is a view illustrating an example of a screen on which a cut-out range of a cut-out image can be adjusted;

FIG. 7 is a view illustrating an example of a screen on which a position of an object can be designated in the cut-out image;

FIG. 8 is a flowchart illustrating an operation of the image generation apparatus;

FIG. 9 is a block diagram illustrating an example of a configuration of the image generation apparatus;

FIG. 10 is a view illustrating an example of a screen on which a distribution map can be confirmed;

FIG. 11 is a view illustrating an example of a screen on which a distribution map is displayed and a cut-out range of a cut-out image can be adjusted;

FIG. 12 is a view illustrating an example of a screen on which a distribution map is displayed and a position of an object in a cut-out image can be designated;

FIG. 13 is a flowchart illustrating an operation of the image generation apparatus; and

FIG. 14 is a view illustrating an example of a hardware configuration of the image generation apparatus.

### EXAMPLE EMBODIMENT

Example embodiments of the present disclosure will be described in detail with reference to the drawings.

### First Example Embodiment

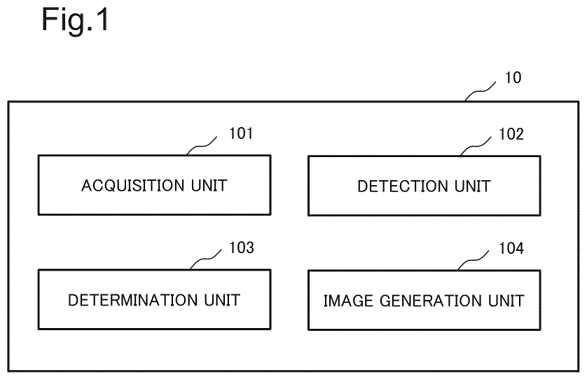

A configuration of an image generation apparatus 10 will be described with reference to FIG. 1. FIG. 1 is a block diagram illustrating an example of a configuration of the image generation apparatus 10. The image generation apparatus 10 includes an acquisition unit 101, a detection unit 102, a determination unit 103, and an image generation unit 104.

The acquisition unit 101 is an aspect of acquisition means for acquiring an SAR image. The SAR image is an image captured by a synthetic aperture radar. The SAR image is an image obtained by imaging a ground surface from a satellite or an aircraft. The SAR image is not limited thereto. The captured SAR image is stored in, for example, a database (not illustrated). Therefore, the acquisition unit 101 can acquire the SAR image from the database. Here, the image generation apparatus 10 and the database are connected by a wired or wireless network. The acquisition unit 101 can acquire a plurality of the SAR images.

The detection unit 102 is an aspect of detection means for detecting an object included in each of the SAR images. Examples of the object include a ship, an aircraft, and a vehicle. Examples of the object are not limited thereto. The object may be an object to be imaged by the synthetic aperture radar. In the following description, a result detected by the detection unit 102 is referred to as a detection result. The detection result includes a position of the object in the SAR image. In addition, the detection result includes a type of the detected object. That is, the detection result is a result indicating which object has been detected and where in the SAR image.

For example, the detection unit 102 can detect an object included in the SAR image by using a trained model. The detection unit 102 can use a model trained in advance for the object. When the SAR image is input, the trained model can output a detection result of the object included in the SAR image. The SAR image and the detection result of the image obtained by the trained model are associated with each other.

The detection unit 102 may detect the object included in the SAR image by acquiring a result of detection of the object by the user. The user observes the SAR image and detects an object included in the SAR image. Then, the user inputs a detection result by using, for example, an input device (not illustrated). The detection unit 102 acquires a detection result input by the user. That is, the detection unit 102 can detect an object included in the SAR image. The detection result input by the user may be stored in, for example, a database. In this case, the detection unit 102 acquires the detection result from the database. That is, the detection unit 102 can detect an object included in the SAR image. The SAR image and the detection result of the image by the user are associated with each other. Therefore, the detection unit 102 acquires the SAR image and the detection result of the image by the user which are associated with each other.

A detection method by the detection unit 102 is not limited thereto. Detection of an object included in the SAR image is performed by using a known technology.

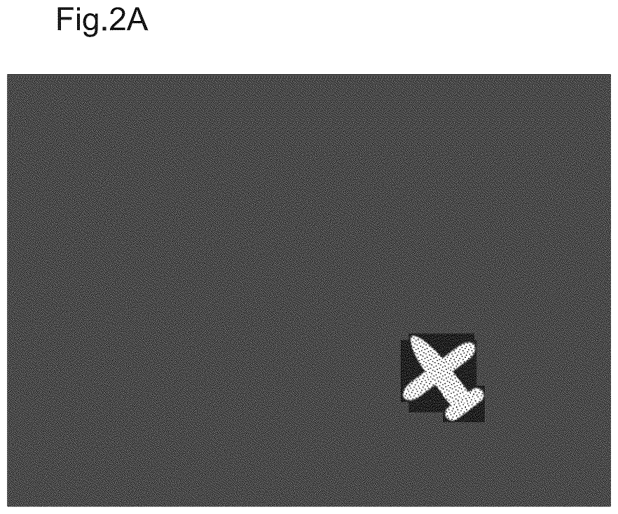

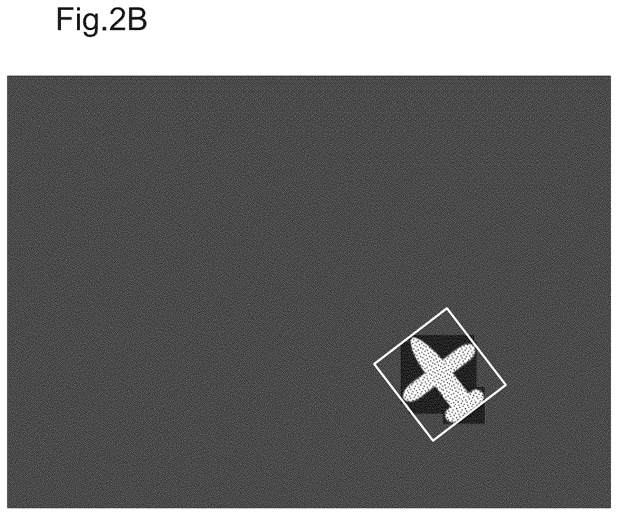

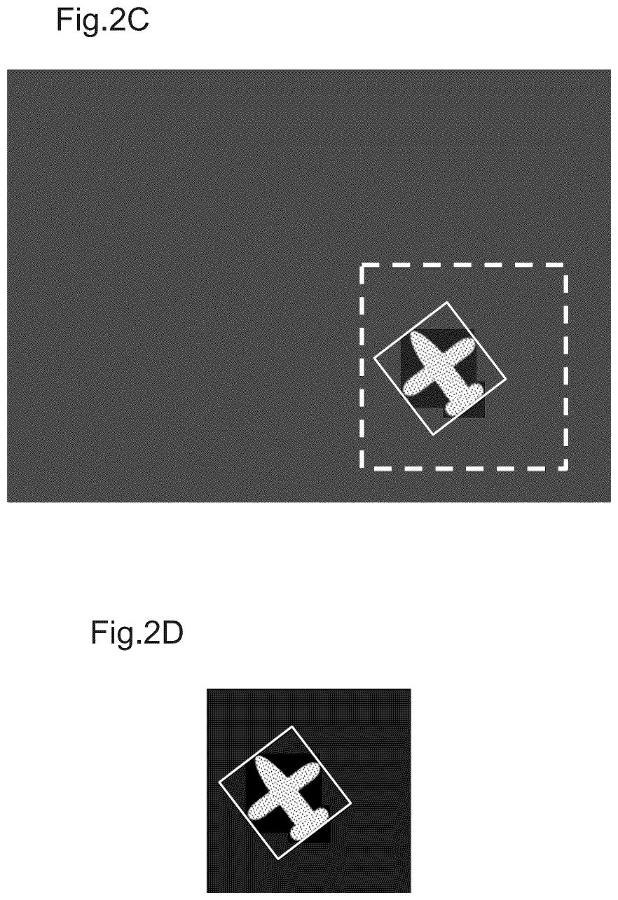

Detection of an object will be described with reference to FIGS. 2A and 2B. FIGS. 2A to 2D are views illustrating an example of an SAR image and a cut-out image. FIG. 2A is a view illustrating an example of the SAR image acquired by the acquisition unit 101. In the example illustrated in FIGS. 2A to 2D, the object included in the SAR image is an aircraft. FIG. 2B is a view illustrating an example of an SAR image including a detection result by the detection unit 102. In FIG. 2B, the detection result is represented by a white solid square. Referring to FIG. 2B, the aircraft that is an object is surrounded by the white solid square. In the SAR image, a range in which the object is detected is referred to as a detection range. That is, in the example shown in FIGS. 2A to 2D, the detection range is a range represented by the white solid square. The detection result and the SAR image may be associated with each other by superimposing the detection result on the SAR image as illustrated in FIG. 2B. The detection result and the SAR image may be associated with each other by, for example, a file name.

The determination unit 103 is an aspect of determination means for determining a size of a cut-out image corresponding to the object. The cut-out image is an image that is cut out from the SAR image. The size of the cut-out image is a size of a cut-out range in which the image is cut out from the SAR image. The size of the cut-out image is expressed as, for example, 512 pixels×512 pixels. Examples of the size of the cut-out image are not limited thereto. In addition, the shape of the cut-out image is not limited to a square. The shape of the cut-out image may be a shape corresponding to a specification of a model to be trained by using the cut-out image.

The determination unit 103 determines a size of a cut-out image corresponding to the object. The size of the cut-out image is smaller than that of the SAR image. Here, the size of the image is a pixel size of the image. Therefore, the pixel size of the cut-out image is smaller than the pixel size of the SAR image. The size of the cut-out image is larger than that of the object included in the SAR image. That is, the size of the cut-out image is larger than the detection range of the object detected by the detection unit 102.

Examples of the object include a ship, an aircraft, and a vehicle as described above. The size of the object may be different for each object. Therefore, the size of the object imaged in the SAR image may vary depending on an object. That is, the detection range of the object detected by the detection unit 102 may be different depending on an object. Therefore, the determination unit 103 can determine the size of the cut-out image in correspondence with the size of the object. For example, in a case where the object is a ship, the size may be determined as 1024 pixels×1042 pixels. Furthermore, in a case where the object is an aircraft, the size of the cut-out image can be determined as 512 pixels×512 pixels.

The size of the cut-out image corresponding to the object is set in advance. The information in which the object is associated with the size of the cut-out image corresponding to the object is stored in, for example, a database. Therefore, the determination unit 103 refers to the above-described information and determines the size of the cut-out image corresponding to the object detected by the detection unit 102.

The determination unit 103 may determine the size of the cut-out image corresponding to resolution of the SAR image. It may be desirable that the cut-out image has a size corresponding to the resolution of the SAR image. Therefore, the determination unit 103 may determine the size of the cut-out image corresponding to the resolution of the SAR image. Depending on the resolution of the SAR image, the pixel size of the SAR image varies. Therefore, the pixel size of the cut-out image may be different. In addition, the determination unit 103 may determine the size of the cut-out image corresponding to the resolution of the synthetic aperture radar. For example, the resolution of the SAR image may vary depending on the resolution of the synthetic aperture radar. It may be desirable that the cut-out image has a size corresponding to the resolution of the SAR image. Therefore, the determination unit 103 may determine the size of the cut-out image corresponding to the resolution of the synthetic aperture radar.

The resolution of the SAR image or the size of the cut-out image corresponding to the resolution of the synthetic aperture radar may be set in advance. Information in which the resolution of the synthetic aperture radar is associated with the size of the cut-out image corresponding to the resolution is stored in, for example, a database. In addition, information in which the resolution of the SAR image is associated with the size of the cut-out image corresponding to the resolution is stored in, for example, a database. Therefore, the determination unit 103 refers to the above-described information and determines the size of the cut-out image corresponding to the object detected by the detection unit 102.

The image generation unit 104 is an aspect of image generation means for generating a cut-out image by cutting out an image having the determined size from the SAR image in such a way that the position of the object in the cut-out image is random. The image generation unit 104 cuts out an image having the size determined by the determination unit 103 from the SAR image. The image generation unit 104 cuts out an image from the SAR image to generate a cut-out image.

Here, the cut-out image will be described again with reference to FIGS. 2A to 2D. FIGS. 2A and 2B are as described above. FIG. 2C is a view illustrating an example of the SAR image showing the cut-out range. That is, FIG. 2C is an SAR image in which the cut-out range is additionally shown in FIG. 2B. In FIG. 2C, a rectangle indicated by a white dotted line is the cut-out range of the image by the image generation unit 104. FIG. 2D is a view illustrating an example of the cut-out image obtained from the SAR image by the image generation unit 104.

The image generation unit 104 cuts out an image in such a way that the position of the object in the cut-out image is random. That is, the image generation unit 104 cuts out the image in such a way that the position of the object in the cut-out image varies. The image generation unit 104 cuts out an image from the SAR image in such a way that the position of the object in the cut-out image is not deviated to a partial range.

As described above, the size of the cut-out image is larger than that of the object. Therefore, in the cut-out image, the position of the object may be partially deviated. That is, when a plurality of images are cut out, there may be a portion where an appearance rate of the object is high and a portion where the appearance rate of the object is low. However, when a machine learning model that recognizes an object is trained, if there is a deviation in the position of the object in the cut-out image, the position of the object may be trained as one of feature amounts. Therefore, it may be desirable that the appearance rate of the object in the cut-out image is uniform. That is, it may be desirable that the position of the object in the cut-out image is not deviated to a partial range. The image generation unit 104 cuts out the image in such a way that the position of the object in the cut-out image is random, thereby reducing the deviation of the position of the object in the cut-out image. That is, an influence of the position of the object in the cut-out image is reduced. Here, the appearance rate of the object may not be strictly uniform. That is, the “random” does not have to be strictly random. In the cutting-out of an image in which the position of the object is random, it is sufficient that the position of the object in the cut-out image varies to such an extent that the position of the object is not trained as one of the feature amounts when the cut-out image is used as the training data. The image generation unit 104 generates the cut-out image in such a way that the position of the object in the cut-out image is random to such an extent that the position of the object is not trained as one of the feature amounts.

Description will be given of an example of a method in which the image generation unit 104 cuts out a cut-out image in such a way that the position of the object in the cut-out image is random. The image generation unit 104 can determine the cut-out range by using a reference point of the detection range. The cut-out range is a range of the cut-out image in the SAR image. That is, the cut-out range is a range in which the image generation unit 104 cuts out the cut-out image from the SAR image. For example, the image generation unit 104 randomly determines the position of the reference point in the detection range where the object is detected in the cut-out image. For example, the image generation unit 104 can determine coordinates of the position of the reference point of the detection range within the cut-out range by using a random number. In addition, the image generation unit 104 may determine the coordinates of the position of the reference point in the detection range in the cut-out range by using a pseudo random number. The image generation unit 104 can determine the cut-out range in which an image is cut out from the SAR image from the position of the reference point of the detection range in the cut-out range and the size of the cut-out image. An example of the reference point of the detection range is the center of the detection range. Another example of the reference point of the detection range is one vertex of the detection range. The reference point of the detection range is not limited thereto.

The image generation unit 104 can generate a plurality of cut-out images from one SAR image. At this time, the image generation unit 104 changes the position of the reference point of the detection range within the cut-out range for each cut-out image. As a result, the image generation unit 104 can generate a cut-out image in a different cut-out range for each cut-out image. That is, the image generation unit 104 can reduce a positional deviation of the object in each of the plurality of cut-out images generated from one SAR image. The image generation unit 104 can determine the position of the reference point of the detection range within the cut-out range by using a random number or a pseudo random number for each cut-out image.

Here, the entire detection range of the object needs to be included in the cut-out image. Therefore, the image generation unit 104 cuts out an image from the SAR image in such a way that the entire detection range of the object falls within the cut-out image. That is, the image generation unit 104 generates the cut-out image in such a way that the entire detection range is included in the cut-out image. The image generation unit 104 needs to determine the cut-out range in such a way that the detection range of the object does not protrude from the cut-out image. Based on the size of the detection range detected by the detection unit 102, the image generation unit 104 can determine the cut-out range in such a way that the detection range of the object is included in the cut-out image.

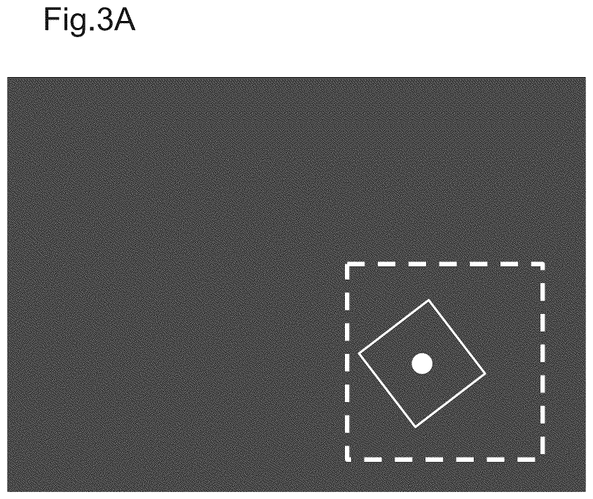

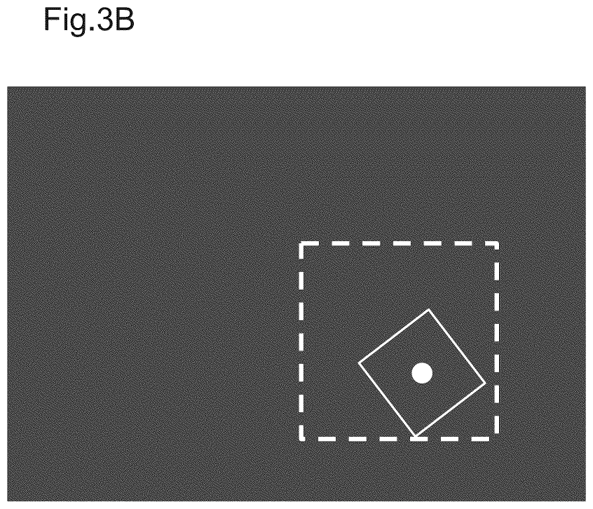

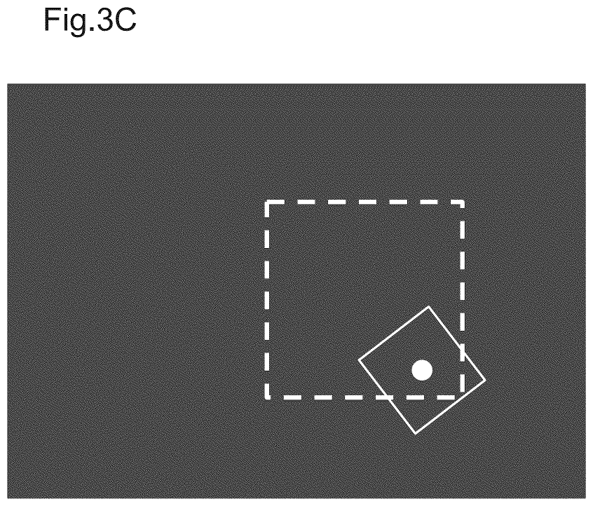

Cutting of an image by the image generation unit 104 will be described with reference to FIGS. 3A to 3C. FIGS. 3A to 3C are views illustrating an example of the cut-out range of the SAR image. A display method of the SAR image, the detection range, and the cut-out range in FIGS. 3A to 3C is similar as in FIGS. 2A to 2D. In FIGS. 3A to 3C, a reference point of the detection range is the center of the detection range and is represented by a white point. FIGS. 3A and 3B are examples of the cut-out range in a case where the entire detection range of the object falls within the cut-out image. FIG. 3C is an example of the cut-out range in a case where a part of the detection range of the object protrudes from the cut-out image. As in the example illustrated in FIG. 3C, the cut-out image in which a part of the detection range of the object protrudes from the cut-out image is not appropriate as the training data. For example, as illustrated in FIG. 3A or 3B, the image generation unit 104 cuts out an image from the SAR image in such a way that the entire detection range of the object falls within the cut-out image.

The image generation unit 104 can use a known technology for determining the cut-out range. In addition, the image generation unit 104 can use a known technology for cutting out an image.

The image generation unit 104 stores the generated cut-out image as the training data. The image generation unit 104 may store the generated cut-out image in, for example, a database. The image generation unit 104 stores the cut-out image and the detection result in association with each other. The cut-out image and the detection result may be associated with each other, for example, by superimposing the detection result on the cut-out image. In addition, the cut-out image and the detection result may be associated with each other by, for example, a file name.

In addition, the image generation unit 104 may generate a cut-out image obtained by cutting out the SAR image in such a way as to include a similar object. The similar object is similar in appearance to the object in the SAR image. In a case where the object is a ship, the similar object is, for example, a marine organism or a wave. The similar object may also be noise contained in the SAR image. First, the detection unit 102 detects a similar object that looks similar to the object. At this time, the detection unit 102 can detect the similar object by acquiring a detection result in which the user has detected the similar object. A method of acquiring the detection result by the user by the detection unit 102 is as described above. In addition, the detection unit 102 may detect the similar object by using a trained model for detection of the similar object. Then, the image generation unit 104 generates a cut-out image that is cut out from the SAR image in such a way as to include the similar object. The size of the cut-out image is a size determined by the determination unit 103. In addition, the image generation unit 104 determines the cut-out range in such a way that the cut-out image includes the entire detection range of the similar object.

The image generation unit 104 may generate the cut-out image in such a way that positions of the similar object in the cut-out image are random. That is, the image generation unit 104 may cut out an image from the SAR image in such a way that the position of the similar object in the cut-out image is random. A method of cutting out an image from the SAR image in such a way that the positions of the similar object in the cut-out image are random is similar to the method of generating the cut-out image including the object. That is, the image generation unit 104 can cut out the image including the similar object by a similar method as in the case of cutting out the image including the object. For example, the image generation unit 104 can determine a cut-out range by using a reference point of a detection range of the similar object.

Then, for example, the image generation unit 104 may store the cut-out image including the similar object in a database as training data. At this time, the cut-out image including the similar object is stored in association with the cut-out image including the object similar to the similar object. For example, in a case where the object is a ship, a cut-out image including the ship and a cut-out image including a similar object similar in appearance to the ship are stored in association with each other. In addition, the image generation unit 104 can store the image including the similar object while distinguishing the image from the cut-out image including the object. In addition, the image generation unit 104 can distinguish and store the cut-out image including the similar object from the cut-out image not including the object.

The image generation unit 104 may also generate a cut-out image obtained by cutting out the SAR image so as not to include any object. The image generation unit 104 cuts out an image from the SAR image with an image size determined by the determination unit 103. At this time, the image generation unit 104 determines the cut-out range so as not to include the object detected by detection unit 102. Then, the image generation unit 104 can generate a cut-out image not including the object by cutting out the SAR image in the cut-out range. The image generation unit 104 may store the cut-out image not including the object in, for example, a database. At this time, the image generation unit 104 can store the image not including the object while distinguishing the image from the cut-out image including the object.

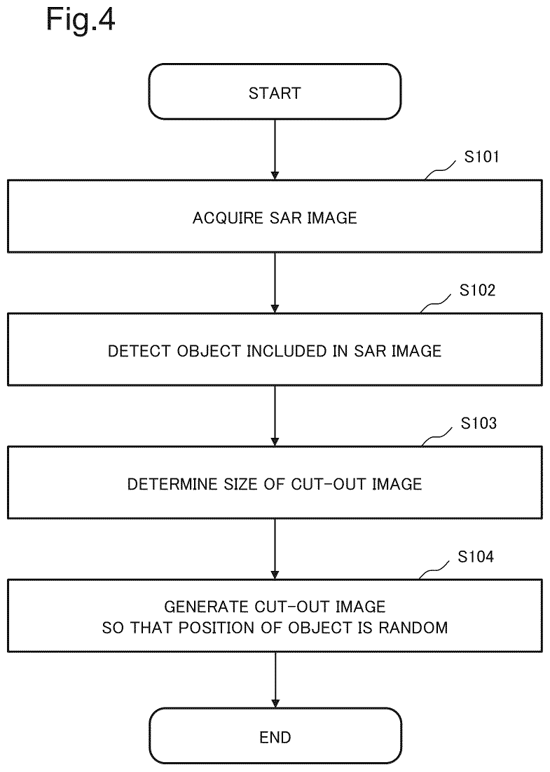

The operation of the image generation apparatus 10 including the acquisition unit 101, the detection unit 102, the determination unit 103, and the image generation unit 104 will be described with reference to FIG. 4. FIG. 4 is a flowchart illustrating an operation of the image generation apparatus 10.

In step S101, the acquisition unit 101 acquires an SAR image. In step S102, the detection unit 102 detects an object included in the SAR image. Then, in step S103, the determination unit 103 determines the size of the cut-out image corresponding to the object. In step S104, the image generation unit 104 generates the cut-out image in such a way that the position of the object in the cut-out image is random. Then, the image generation apparatus 10 terminates the operation.

In a case where the image generation apparatus 10 generates a plurality of cut-out images, the above-described flow can be repeated. For example, after the image generation unit 104 generates the cut-out image in step S104, the flow from step S101 to step S104 may be repeated again. That is, after step S104, the acquisition unit 101 acquires a new SAR image. Then, according to the flow from step S102 to step S104, the image generation apparatus 10 can generate a cut-out image for the new SAR image.

In addition, after the image generation unit 104 generates the cut-out image in step S104, the flow from step S102 to step S104 may be repeated again. For example, a plurality of objects may be imaged in one SAR image. Therefore, in step S102, the detection unit 102 detects the object included in the SAR image again. Then, in step S103, the determination unit 103 determines the size of the cut-out image corresponding to the newly detected object. When the newly detected object is the same as the object detected already, step S103 may be omitted. Then, in step S104, the image generation unit 104 generates a cut-out image.

Furthermore, after the image generation unit 104 generates the cut-out image in step S104, the flow of step S104 may be repeated again. That is, the image generation unit 104 may generate a plurality of cut-out images from one SAR image in such a way that positions of the objects included in the cut-out images are different.

In the present example embodiment, the image generation apparatus 10 generates a cut-out image obtained by the image generation unit 104 that cuts out an image having a determined size from the SAR image in such a way that the position of the object in the cut-out image is random. The cut-out image is used, for example, as training data when training a machine learning model that recognizes an object. Therefore, the image generation unit 104 generates the cut-out image in such a way that the position of the object in the cut-out image is random. Therefore, it is possible to reduce a positional deviation of the object in the cut-out image. That is, it is possible to reduce the influence of the position of the object in the cut-out image. The image generation unit 104 generates the cut-out image in such a way that the position of the object in the cut-out image is random to such an extent that the position of the object is not trained as one of the feature amounts. Therefore, it is possible to prevent the position of the object in the cut-out image from being learned as one of the feature amounts.

In the present example embodiment, in the image generation apparatus 10, the image generation unit 104 generates a cut-out image in such a way that the entire detection range is included in the cut-out image. As described above, the cut-out image is used as training data. Therefore, the entirety of the object included in the SAR image needs to be included in the cut-out image. Therefore, the image generation unit 104 generates a cut-out image in such a way that the entire detection range is included in the cut-out image, whereby an appropriate cut-out image can be generated as the training data.

In the present example embodiment, in the image generation apparatus 10, the detection unit 102 detects a similar object having an appearance similar to that of the object, and the image generation unit 104 generates a cut-out image in such a way that a position of the similar object in the cut-out image is random. By generating a cut-out image including a similar object, the cut-out image can be used as training data. Then, by using the cut-out image including the similar object as the training data, the learning accuracy of the object detection can be improved. In addition, by generating the cut-out image in such a way that the position of the similar object in the cut-out image is random, it is possible to prevent the position of the similar object from being learned as one of the feature amounts.

In the image generation apparatus 10, the image generation unit 104 generates a cut-out image that is cut out from the SAR image so as not to include the object. By generating a cut-out image not including an object, the cut-out image can be used as training data. Then, the accuracy of learning of object detection can be improved by using the cut-out image not including the object as the training data.

### Second Example Embodiment

Next, a second example embodiment of the present disclosure will be described in detail with reference to the drawings. Hereinafter, description of contents overlapping with the above description will be omitted to the extent that description of the present example embodiment is not unclear.

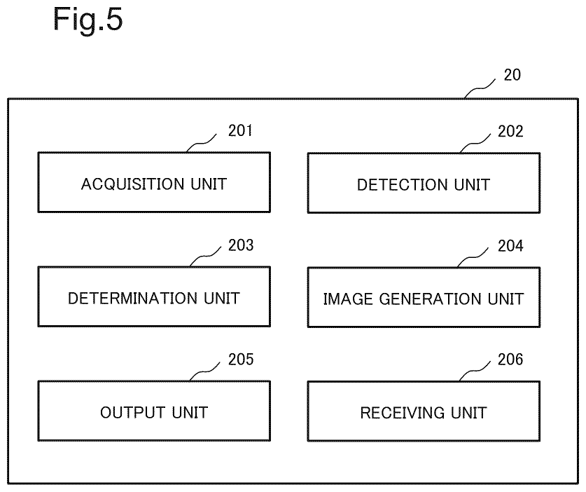

A configuration of an image generation apparatus 20 will be described with reference to FIG. 5. FIG. 5 is a block diagram illustrating an example of a configuration of the image generation apparatus 20 The image generation apparatus 20 includes an acquisition unit 201, a detection unit 202, a determination unit 203, an image generation unit 204, and an output unit 205. The image generation apparatus 20 may include a receiving unit 206.

The acquisition unit 201, the detection unit 202, the determination unit 203, and the image generation unit 204 are similar to those of the first example embodiment.

The output unit 205 is an aspect of output means for outputting a screen on which a cut-out range of a cut-out image can be adjusted. The output unit 205 outputs, for example, a screen to be displayed on a display device (not illustrated). The display device displays the screen output by the output unit 205. Then, a user can confirm the screen displayed on the display device. The display device and the image generation apparatus 20 are connected by a wired or wireless network.

The output unit 205 can output a screen on which the cut-out image can be confirmed. The cut-out image is generated by the image generation unit 204. Then, the output unit 205 outputs a screen in a mode in which the user can confirm the cut-out image. On the screen on which the cut-out image can be confirmed, the cut-out image may be enlarged or reduced. Furthermore, in a case where the image generation unit 204 generates a plurality of cut-out images, the output unit 205 may output a screen that displays a list of the plurality of cut-out images.

In addition, the output unit 205 outputs a screen on which a cut-out range of the cut-out image can be adjusted. When confirming the cut-out image generated by the image generation unit 204, the user may desire to adjust the cut-out range of the cut-out image. Therefore, the output unit 205 outputs a screen on which the cut-out range of the cut-out image can be adjusted. The size of the cut-out range is a size of the cut-out image determined by the determination unit 203. Therefore, the output unit 205 outputs a screen on which the position of the cut-out range of the cut-out image can be adjusted.

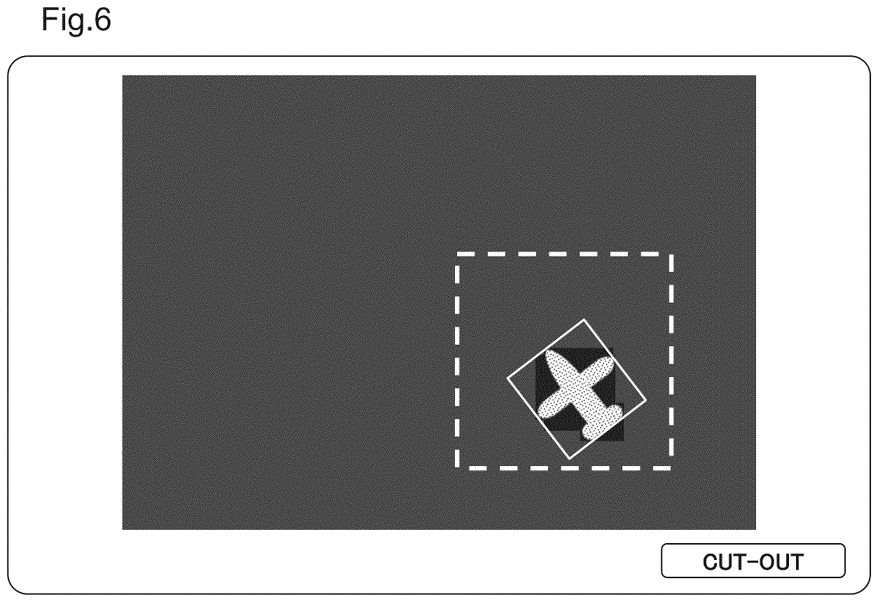

With reference to FIG. 6, the screen on which the cut-out range of the cut-out image can be adjusted will be described. FIG. 6 is a view illustrating an example of the screen on which the cut-out range of the cut-out image can be adjusted. In FIG. 6, an object included in the SAR image is an aircraft. In addition, in FIG. 6, the cut-out range is indicated by a white dotted line. A detection range of the object is indicated by a white solid line. For example, when a user touches the screen, a position of the cut-out range can be moved up, down, left, and right. The output unit 205 may display a button for moving the cut-out range up, down, left, and right on the screen. In addition, a “cut-out” button is displayed on the screen illustrated in FIG. 6. In a case where the user desires to cut out an image in the adjusted cut-out range, the user can press the “cut-out” button.

Here, the image generation apparatus 20 may include a receiving unit 206. The receiving unit 206 is an aspect of receiving means for receiving an instruction to generate a cut-out image in the adjusted cut-out range. That is, when the above-described “cut-out” button is pressed, the receiving unit 206 receives an instruction to cut out an image in the cut-out range adjusted on the screen and generate a cut-out image. Then, the image generation unit 204 can cut out an image in the adjusted cut-out range to generate a cut-out image.

FIG. 6 is an example of a screen on which the cut-out range of the cut-out image can be adjusted. The screen on which the cut-out range of the cut-out image can be adjusted is not limited thereto.

The output unit 205 will be described again. The output unit 205 may output a screen on which a position of the object in the cut-out image can be designated. There is a case where the user desires to designate the position of the object in the cut-out image. Therefore, the output unit 205 may output a screen on which the position of the object in the cut-out image can be designated.

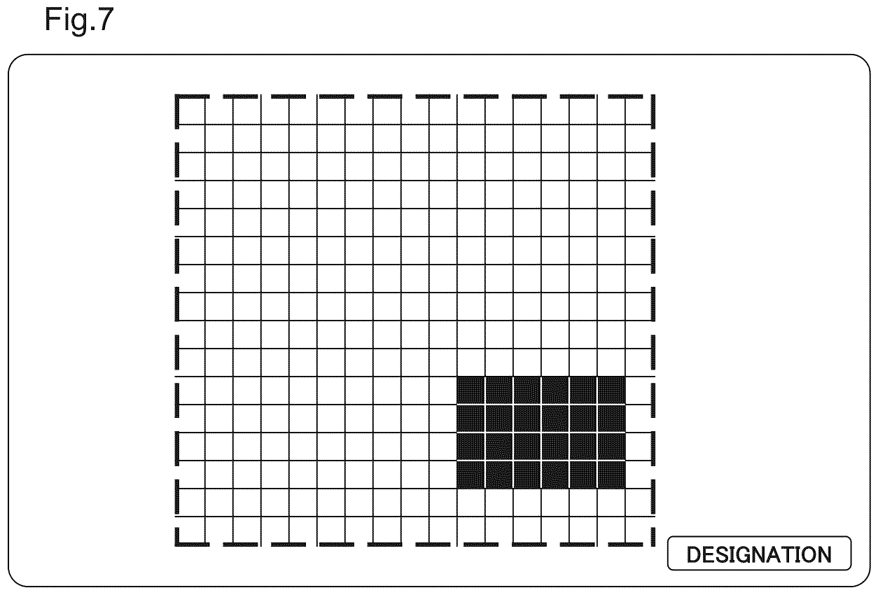

With reference to FIG. 7, a screen on which a position of an object can be designated in the cut-out image will be described. FIG. 7 is a view illustrating an example of the screen on which the position of the object can be designated in the cut-out image. In FIG. 7, a range represented by a dotted line represents a range of the cut-out image. The inside of the cut-out image is divided into squares. A user can select a square corresponding to a desired position of the object. In FIG. 7, squares filled in black are selected squares. The user can designate the position of the object by selecting the squares. After selecting the squares, the user may press the “designation” button on the screen illustrated in FIG. 7.

In a case where the image generation apparatus 20 includes the receiving unit 206, the receiving unit 206 receives designation of the position of the object in the cut-out image. That is, when the “designation” button is pressed, the receiving unit 206 can receive the designation of the position of the object in the cut-out image. Then, the image generation unit 204 generates a cut-out image in such a way that the object is included at the designated position.

The image generation unit 204 cuts out an image from the SAR image in such a way that a detection range is included at the position of the object for which the designation has been received by the receiving unit 206. The image generation unit 204 may cut out the image from the SAR image in such a way that the position of the object for which the designation has been received by the receiving unit 206 includes the entire detection range. In addition, the image generation unit 204 may cut out the image from the SAR image in such a way that the position of the object for which the designation has been received by the receiving unit 206 includes a part of the detection range.

FIG. 7 is an example of the screen on which the position of the object can be designated in the cut-out image. The screen on which the position of the object can be designated in the cut-out image is not limited thereto.

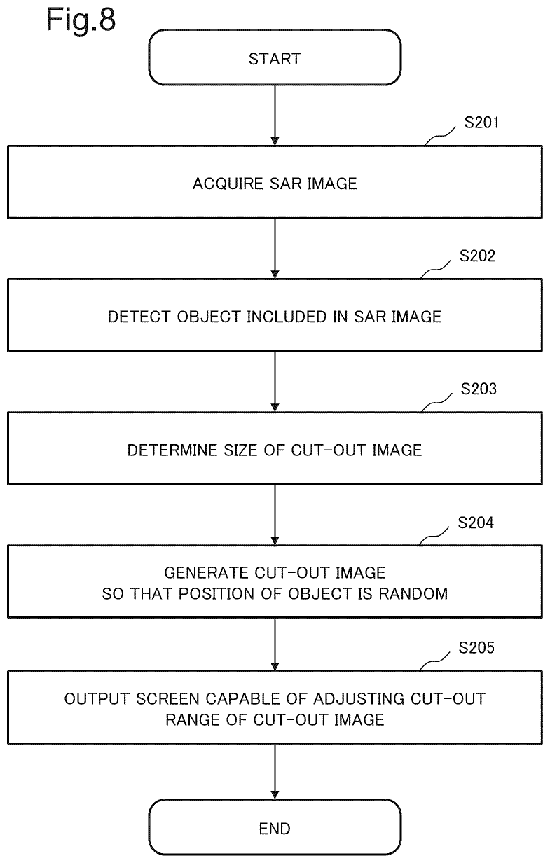

The operation of the image generation apparatus 20 including the acquisition unit 201, the detection unit 202, the determination unit 203, the image generation unit 204, and the output unit 205 will be described with reference to FIG. 8. FIG. 8 is a flowchart illustrating an operation of the image generation apparatus 20.

Step S201, step S202, step S203, and step S204 in FIG. 8 are similar to step S101, step S102, step S103, and step S104 in FIG. 4, respectively.

In step S205, the output unit 205 outputs a screen on which the cut-out range of the cut-out image can be adjusted. Then, the image generation apparatus 20 terminates the operation. In a case where the image generation apparatus 20 includes the receiving unit 206, after step S205, the receiving unit 206 receives an instruction to generate a cut-out image in the adjusted cut-out range. Then, the image generation unit 204 generates a cut-out image in the adjusted cut-out range. Then, the image generation apparatus 20 terminates the operation. Here, the screen output by the output unit 205 is not limited to the screen on which the cut-out range of the cut-out image can be adjusted. The output unit 205 can output the above-described screen.

In the present example embodiment, the image generation apparatus 20 includes the output unit 205 that outputs a screen on which the cut-out range of the cut-out image can be adjusted. In addition, the image generation apparatus 20 further includes the receiving unit 206 that receives an instruction to generate a cut-out image in the adjusted cut-out range. Then, in the image generation apparatus 20, the image generation unit 204 generates a cut-out image in the adjusted cut-out range. A user may desire to conform the cut-out image and adjust the cut-out range if necessary. Therefore, the output unit 205 outputs a screen on which the cut-out range of the cut-out image can be adjusted in such a way that the user can confirm the cut-out image. In addition, since the output unit 205 outputs a screen on which the cut-out range of the cut-out image can be adjusted, the user can adjust the cut-out range as necessary. Then, when receiving unit 206 receives the instruction to generate the cut-out image in the adjusted cut-out range, the image generation unit 204 generates the cut-out image in the adjusted cut-out range. Therefore, it is possible to generate the cut-out image in the cut-out range adjusted by the user. That is, the cut-out range can be adjusted in correspondence with user's desire.

The output unit 205 may also output a screen on which a position of the object in the cut-out image can be designated. The user may have a preference for the position of the object in the cut-out image. Therefore, the user can designate the position of the object on the screen that can designate the position of the object in the cut-out image output by the output unit 205. Then, the receiving unit 206 receives designation of the position of the object in the cut-out image, and the image generation unit 204 generates the cut-out image in such a way that the object is included at the designated position. Then, the image generation unit 204 generates the cut-out image in such a way that the object is included at the designated position.

### Third Example Embodiment

Next, a third example embodiment of the present disclosure will be described in detail with reference to the drawings. Hereinafter, description of contents overlapping with the above description will be omitted to the extent that description of the present example embodiment is not unclear.

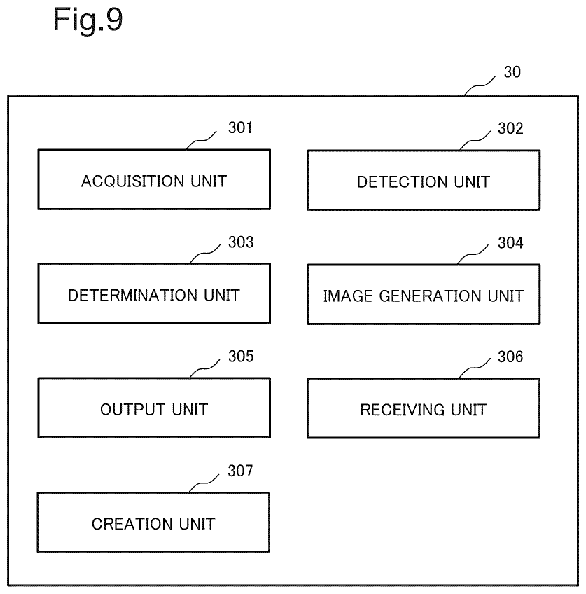

A configuration of an image generation apparatus 30 will be described with reference to FIG. 9. FIG. 9 is a block diagram illustrating an example of a configuration of the image generation apparatus 30 The image generation apparatus 30 includes an acquisition unit 301, a detection unit 302, a determination unit 303, an image generation unit 304, an output unit 305, and a creation unit 307. The image generation apparatus 30 may include a receiving unit 306.

The acquisition unit 301, the detection unit 302, the determination unit 303, the image generation unit 304, the output unit 305, and the receiving unit 306 are similar to those in the above-described example embodiment.

The creation unit 307 is an aspect of creation means for creating a distribution map representing a positional deviation of an object in a cut-out image. The creation unit 307 creates a distribution map illustrating a deviation of a position of a detection range in which the object is detected in a plurality of cut-out images generated by the image generation unit 304. An example of the distribution map is a heat map. The creation unit 307 can visualize the deviation of the position of the object in the cut-out image in the distribution map. The distribution map is created by using a known technology.

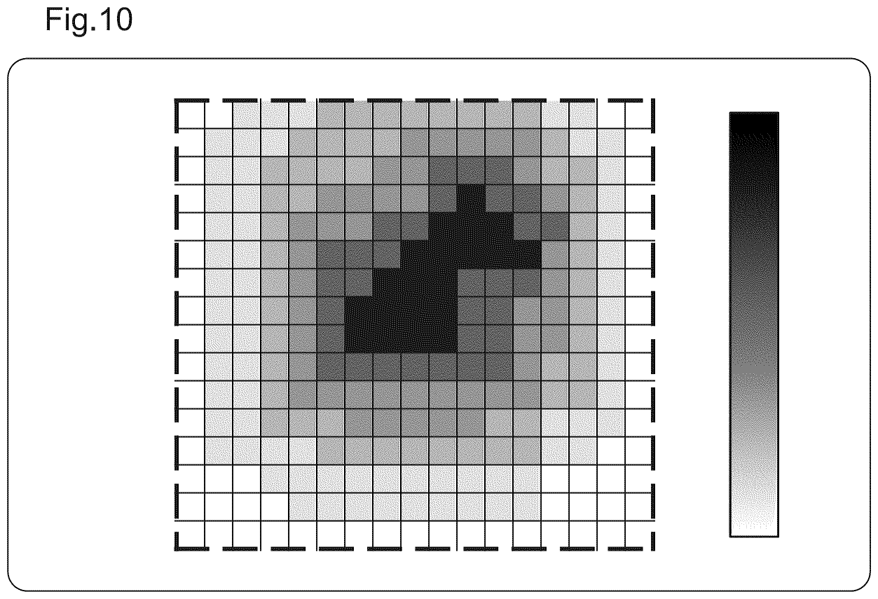

The output unit 305 may output a screen on which the distribution map created by the creation unit 307 can be confirmed. A screen on which the distribution map can be confirmed will be described with reference to FIG. 10. FIG. 10 is a view illustrating an example of the screen on which the distribution map can be confirmed. In the example of the screen illustrated in FIG. 10, a heat map is displayed as the distribution map. In the heat map, a proportion at which the object is located is represented in grayscale. In the heat map, a range in which the proportion at which the object is located is high is indicated in black, and a range in which the proportion at which the object is located is low is indicated in white. The heat map is an example, and there is no limitation thereto. In the heat map, the proportion at which the object is located may be represented by a color or may be represented by a filling method.

The output unit 305 may output a screen on which the distribution map and the cut-out image can be confirmed. The output unit 305 may output, for example, a screen on which the distribution map and the cut-out image are displayed side by side. Furthermore, in a case where the image generation unit 304 generates a plurality of cut-out images, the output unit 305 may output a screen displaying a distribution map and a list of the cut-out images.

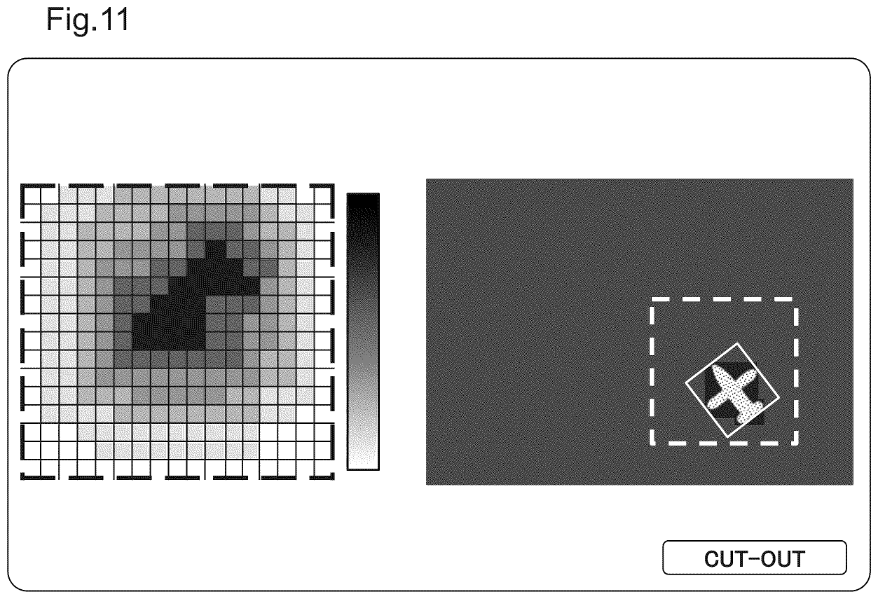

The output unit 305 may display a distribution map and output a screen on which the cut-out range of the cut-out image can be adjusted. With reference to FIG. 11, a screen on which the distribution map is displayed and the cut-out range of the cut-out image can be adjusted will be described. FIG. 11 is a view illustrating an example of a screen on which the distribution map is displayed and the cut-out range of the cut-out image can be adjusted. A distribution map and an SAR image are displayed on the screen illustrated in FIG. 11. The heat map is similar to the heat map illustrated in FIG. 10. The SAR image is similar to FIG. 6. A user can confirm the heat map of FIG. 11 to grasp a positional deviation of the object. Then, the cut-out range of the cut-out image can be adjusted based on the positional deviation of the object. In a case where the image generation apparatus 30 includes the receiving unit 306, the receiving unit 306 can receive an instruction to generate a cut-out image in the adjusted cut-out range. Then, the image generation unit 304 generates a cut-out image in the adjusted cut-out range.

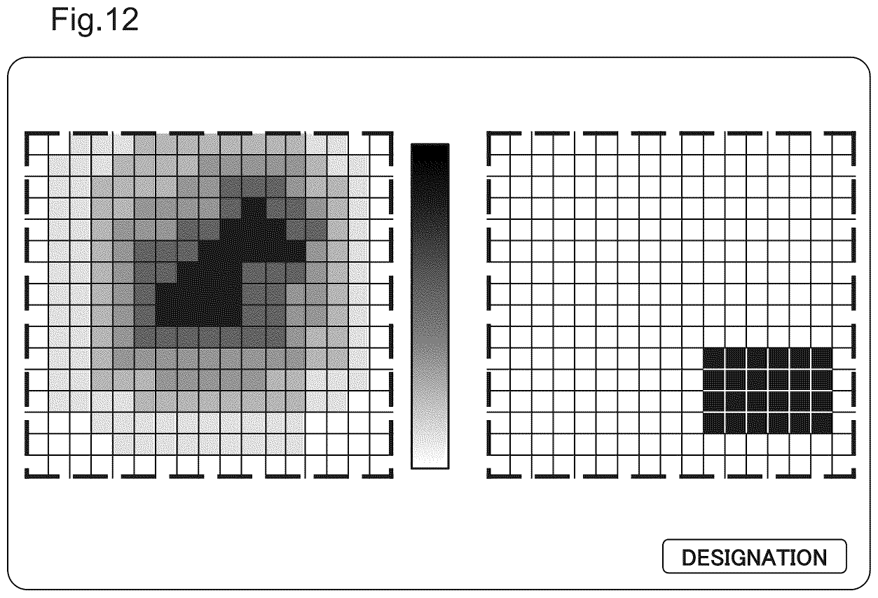

The output unit 305 may display the distribution map and output a screen on which the position of the object in the cut-out image can be designated. With reference to FIG. 12, a screen on which the distribution map is displayed and the position of the object in the cut-out image can be designated will be described. FIG. 12 is a view illustrating an example of a screen on which the distribution map is displayed and the position of the object in the cut-out image can be designated. A distribution map and an SAR image are displayed on the screen illustrated in FIG. 12. The heat map is similar to the heat map illustrated in FIG. 10. In addition, the range for designating the position of the object in the cut-out image is similar to that in FIG. 7. A user can confirm the heat map of FIG. 12 to grasp a positional deviation of the object. Then, the position of the object in the cut-out image can be designated based on the positional deviation of the object. In a case where the image generation apparatus 30 includes the receiving unit 306, the receiving unit 306 can receive designation of the position of the object in the cut-out image. Then, the image generation unit 304 generates a cut-out image in such a way that the object is included at the designated position.

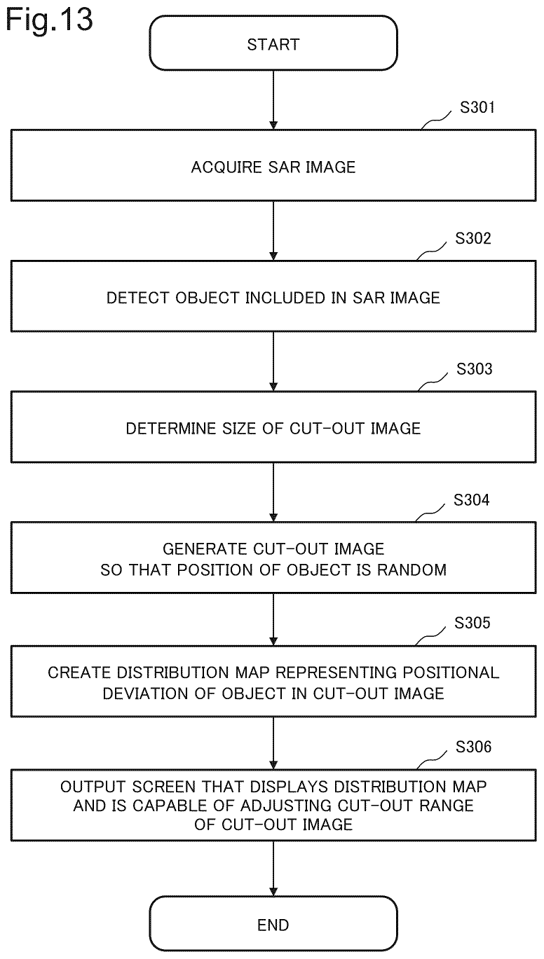

The operation of the image generation apparatus 30 including the acquisition unit 301, the detection unit 302, the determination unit 303, the image generation unit 304, the output unit 305, and the creation unit 307 will be described with reference to FIG. 13. FIG. 13 is a flowchart illustrating an operation of the image generation apparatus 30.

Step S301, step S302, step S303, and step S304 in FIG. 13 are similar to step S101, step S102, step S103, and step S104 in FIG. 4, respectively.

In step S305, the creation unit 307 creates a distribution map representing the positional deviation of the object in the cut-out image. Then, in step S306, the distribution map is displayed, and a screen on which the cut-out range of the cut-out image can be adjusted is output. Then, the image generation apparatus 30 terminates the operation. In a case where the image generation apparatus 30 includes the receiving unit 306, after step S306, the receiving unit 306 receives an instruction to generate a cut-out image in the adjusted cut-out range. Then, the image generation unit 304 generates a cut-out image in the adjusted cut-out range. Then, the image generation apparatus 30 terminates the operation. Here, the screen output by the output unit 305 is not limited to the screen on which the cut-out range of the cut-out image can be adjusted. The output unit 305 can output the above-described screen.

In the present example embodiment, the image generation apparatus 30 further includes the creation unit 307 that creates the distribution map representing the positional deviation of the object in the cut-out image. Then, in the image generation apparatus 30, the output unit 305 further outputs a screen displaying the distribution map. Since the creation unit 307 creates the distribution map, it is possible to visualize the positional deviation of the object in the cut-out image. The distribution map is, for example, a heat map. When the creation unit 307 creates the heat map, the positional deviation of the object in the cut-out image is represented by, for example, a color or a filling method. Then, the output unit 305 outputs the screen on which the distribution map is displayed in such a way that the user can confirm the output screen to confirm the positional deviation of the object in the cut-out image.

In the present example embodiment, in the image generation apparatus 30, the output unit 305 displays the distribution map and outputs the screen on which the position of the object in the cut-out image can be designated. The output unit 305 outputs the screen in such a way that the user can designate the position of the object while confirming the distribution map. For example, the user conforms the positional deviation of the object via the output screen. Then, in a case where there is a portion having a low appearance rate of the object, the user can designate the portion as the position of the object. That is, the user can designate the position of the object in such a way that the object is positioned in a portion where the appearance rate of the object is low. Then, the receiving unit 306 receives designation of the position of the object in the cut-out image, and the image generation unit 304 generates the cut-out image in such a way that the object is included at the designated position. As a result, it is possible to generate a cut-out image in which the positional deviation of the object is reduced in correspondence with the positional deviation of the object which is visualized in the distribution map. That is, it is possible to reduce a positional deviation of the object in the cut-out image. Therefore, it is possible to prevent the position of the object in the cut-out image from being learned as one of the feature amounts. Therefore, it is possible to reduce the positional deviation of the object in the cut-out image.

The output unit 305 may also display the distribution map and output the screen on which the cut-out range of the cut-out image can be adjusted. The user can confirm the distribution map to grasp the positional deviation of the object in the cut-out image. Then, the user can adjust the cut-out range of the cut-out image. Then, the receiving unit 306 receives an instruction to generate a cut-out image in the adjusted cut-out range, and the image generation unit 304 generates a cut-out image in the adjusted cut-out range. As a result, it is possible to generate a cut-out image in which the cut-out range is adjusted in correspondence with the positional deviation of the object whose distribution map is visualized. That is, it is possible to reduce a positional deviation of the object in the cut-out image. Therefore, it is possible to prevent the position of the object in the cut-out image from being learned as one of the feature amounts. As a result, it is possible to reduce the positional deviation of the object in the cut-out image.

### [Hardware Configuration Example]

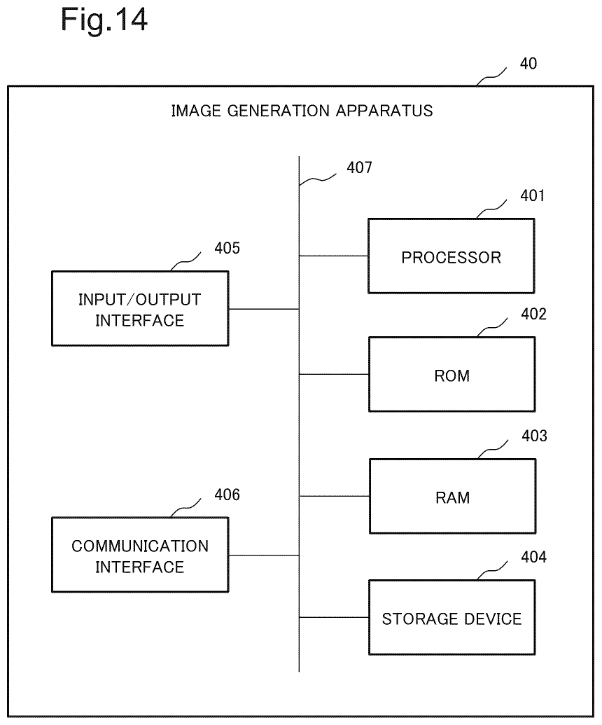

FIG. 14 is a view illustrating a hardware configuration example of an image generation apparatus 40 according to the present disclosure. The image generation apparatus 40 is achieved by a computer. The image generation apparatus 40 is an example of a case where the image generation apparatus 10, the image generation apparatus 20, or the image generation apparatus 30 is implemented by a computer.

The image generation apparatus 40 includes a processor 401, a read only memory (ROM) 402, a random access memory (RAM) 403, a storage device 404 such as a hard disk that stores a program, an input/output interface 405 that inputs/outputs data, and a communication interface 406 for network connection. The constituent units are connected via a bus 407.

The processor 401 operates an operating system to control the entirety of the computer. Examples of the processor 401 include a central processing unit (CPU), a digital signal processor (DSP), and a graphics processing unit (GPU). The processor 401 loads a program stored in, for example, the ROM 402, the storage device 404, or the like. Then, the processor 401 executes each process coded in the program. The processor 401 may execute processing or instructions in the illustrated flowchart based on a program.

The ROM 402 stores an application program, a program according to each example embodiment, and the like. In addition, the RAM 403 is used as a work area of the processor 401.

Examples of the storage device 404 include a semiconductor memory such as a flash memory and a hard disk driver (HDD). The storage device 404 stores, for example, an operating system (OS) program, an application program, a program according to each example embodiment, and the like.

The input/output interface 405 is connected to a peripheral device (not illustrated). The connection method may be a wired network or a wireless network.

The communication interface 406 is connected to a communication network (not illustrated) such as a local network (LAN) or a wide area network (WAN) through a wireless or wired network. Note that the communication network may include a plurality of communication networks. As a result, the computer is connected to an external device via the communication network. The image generation apparatus 40 may include constituent elements other than those illustrated in FIG. 14. For example, the image generation apparatus 40 may include a drive device or the like. For example, the processor 401 may be mounted on a drive device or the like, and may read a program or data stored in a non-transitory tangible recording medium into the RAM 403.

When there is a positional deviation of the object in the cut-out image cut out from the SAR image, the position of the object in the cut-out image may be learned as one of the feature amounts.

An example of an effect of the present disclosure is that an influence of a position of an object in a cut-out image cut out from a SAR image can be reduced.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed disclosure even if the claims are amended during prosecution.

Some or all of the above example embodiments may be described as the following Supplementary Notes, but the present disclosure is not limited to the following Supplementary Notes.

### Supplementary Note 1

An image generation apparatus including:
acquisition means for acquiring a synthetic aperture radar (SAR) image;
detection means for detecting an object included in the SAR image;
determination means for determining a size of a cut-out image corresponding to the object; and
image generation means for generating the cut-out image obtained by cutting out an image having the determined size from the SAR image in such a way that the position of the object in the cut-out image is random.

### Supplementary Note 2

The image generation apparatus according to Supplementary Note 1, wherein
the image generation means generates the cut-out image in such a way that a position of the object in the cut-out image is random to such an extent that the position of the object is not learned as one of feature amounts.

### Supplementary Note 3

The image generation apparatus according to Supplementary Note 1 or 2, wherein
the image generation means randomly determines a position of a reference point of a detection range in which the object is detected in the cut-out image.

### Supplementary Note 4

The image generation apparatus according to any one of Supplementary Notes 1 to 3, wherein
the image generation means generates the cut-out image in such a way that the entire detection range in which the object is detected is included in the cut-out image.

### Supplementary Note 5

The image generation apparatus according to any one of Supplementary Notes 1 to 4, further including:
output means for outputting a screen on which a cut-out range of the cut-out image is capable of being adjusted; and
receiving means for receiving an instruction to generate the cut-out image in the adjusted cut-out range,
wherein the image generation means generates the cut-out image in the adjusted cut-out range.

### Supplementary Note 6

The image generation apparatus according to Supplementary Note 5, wherein
the output means outputs a screen capable of designating a position of the object in the cut-out image,
the receiving means receives designation of the position of the object in the cut-out image, and
the image generation means generates the cut-out image in such a way that the object is included at the designated position.

### Supplementary Note 7

The image generation apparatus according to Supplementary Note 5 or 6, further including:
creation means for creating a distribution map representing a positional deviation of the object in the cut-out image,
wherein the output means further outputs a screen displaying the distribution map.

### Supplementary Note 8

The image generation apparatus according to Supplementary Note 7,
wherein the distribution map is a heat map.

### Supplementary Note 9

The image generation apparatus according to Supplementary Note 7 or 8, wherein
the output means displays the distribution map and outputs a screen on which a cut-out range of the cut-out image is capable of being adjusted,
the receiving means receives an instruction to generate the cut-out image in the adjusted cut-out range, and
the image generation means generates the cut-out image in the adjusted cut-out range.

### Supplementary Note 10

The image generation apparatus according to any one of Supplementary Notes 7 to 9, wherein
the output means outputs the distribution map and a screen capable of designating a position of the object in the cut-out image,
the receiving means receives designation of the position of the object in the cut-out image, and
the image generation means generates the cut-out image in such a way that the object is included at the designated position.

### Supplementary Note 11

The image generation apparatus according to any one of Supplementary Notes 1 to 10, wherein
the detection means detects a similar object that looks similar to the object, and
the image generation means generates the cut-out image in such a way that a position of the similar object in the cut-out image is random.

### Supplementary Note 12

The image generation apparatus according to any one of Supplementary Notes 1 to 11, wherein
the image generation means generates the cut-out image cut out from the SAR image so as not to include the object.

### Supplementary Note 13

An image cutting method including:
acquiring a synthetic aperture radar (SAR) image;
detecting an object included in the SAR image;
determining a size of a cut-out image corresponding to the object; and
generating the cut-out image obtained by cutting out an image having the determined size from the SAR image in such a way that a position of the object in the cut-out image is random.

### Supplementary Note 14

A program causing a computer to execute processing of:
acquiring a synthetic aperture radar (SAR) image;
detecting an object included in the SAR image;
determining a size of a cut-out image corresponding to the object; and
generating the cut-out image obtained by cutting out an image having the determined size from the SAR image in such a way that a position of the object in the cut-out image is random.

### Supplementary Note 15

A recording medium that stores a program causing a computer to execute processing of:
acquiring a synthetic aperture radar (SAR) image;
detecting an object included in the SAR image;
determining a size of a cut-out image corresponding to the object; and
generating the cut-out image obtained by cutting out an image having the determined size from the SAR image in such a way that a position of the object in the cut-out image is random.

Some or all of the configurations described in the Supplementary Notes 2 to 8 dependent on the Supplementary Note 1 described above can also depend on the Supplementary Notes 9 and 10 in the same dependency relationship as in the Supplementary Notes 2 to 8. Without limitation to the Supplementary Notes 1, 9, and 10, within a scope not departing from the above-described example embodiments, some or all of the configurations described as the Supplementary Notes may depend on various kinds of hardware, various kinds of software, various recording devices for recording software, or systems in a similar manner.

1. An image generation apparatus comprising:
at least one memory configured to store instructions; and
at least one processor configured to execute the instructions to:
acquire a synthetic aperture radar (SAR) image;
detect an object included in the SAR image;
determine a size of a cut-out image corresponding to the object; and
generate a cut-out image obtained by cutting out an image having the determined size from the SAR image in such a way that a position of the object in the cut-out image is random.

2. The image generation apparatus according to claim 1, wherein the at least one processor is further configured to execute the instructions to:
generate the cut-out image in such a way that the position of the object in the cut-out image is random to such an extent that the position of the object is not learned as one of feature amounts.

3. The image generation apparatus according to claim 1, wherein the at least one processor is further configured to execute the instructions to:
randomly determine a position of a reference point in a detection range in which the object is detected in the cut-out image.

4. The image generation apparatus according to claim 1, wherein the at least one processor is further configured to execute the instructions to:
generate the cut-out image in such a way that the entire detection range in which the object is detected is included in the cut-out image.

5. The image generation apparatus according to claim 1, wherein the at least one processor is further configured to execute the instructions to:
output a screen on which a cut-out range of the cut-out image is capable of being adjusted;
receive an instruction to generate the cut-out image in the adjusted cut-out range; and
generate the cut-out image in the adjusted cut-out range.

6. The image generation apparatus according to claim 5, wherein the at least one processor is further configured to execute the instructions to:
output a screen capable of designating a position of the object in the cut-out image;
receive designation of the position of the object in the cut-out image; and
generate the cut-out image in such a way that the object is included at the designated position.

7. The image generation apparatus according to claim 5, wherein the at least one processor is further configured to execute the instructions to:
create a distribution map representing a positional deviation of the object in the cut-out image; and
output a screen displaying the distribution map.

8. The image generation apparatus according to claim 7, wherein
the distribution map is a heat map.

9. The image generation apparatus according to claim 7, wherein the at least one processor is further configured to execute the instructions to:
output a screen that displays the distribution map and on which a cut-out range of the cut-out image can be adjusted;
receive an instruction to generate the cut-out image in the adjusted cut-out range; and
generate the cut-out image in the adjusted cut-out range.

10. The image generation apparatus according to claim 7, wherein the at least one processor is further configured to execute the instructions to:
output a screen that displays the distribution map and is capable of designating a position of the object in the cut-out image;
receive designation of the position of the object in the cut-out image; and
generate the cut-out image in such a way that the object is included at the designated position.

11. The image generation apparatus according to claim 1, wherein the at least one processor is further configured to execute the instructions to:
detect a similar object that looks similar to the object; and
generate the cut-out image in such a way that a position of the similar object in the cut-out image is random.

12. The image generation apparatus according to claim 1, wherein the at least one processor is further configured to execute the instructions to:
generate the cut-out image cut out from the SAR image so as not to include the object.

13. An image generation method comprising:
acquiring a synthetic aperture radar (SAR) image;
detecting an object included in the SAR image;
determining a size of a cut-out image corresponding to the object; and
generating the cut-out image obtained by cutting out an image having the determined size from the SAR image in such a way that a position of the object in the cut-out image is random.

14. The image generation method according to claim 13, further comprising:
generating the cut-out image in such a way that the position of the object in the cut-out image is random to such an extent that the position of the object is not learned as one of feature amounts.

15. The image generation method according to claim 13, further comprising:
randomly determining a position of a reference point in a detection range in which the object is detected in the cut-out image.

16. The image generation method according to claim 13, further comprising:
generating the cut-out image in such a way that the entire detection range in which the object is detected is included in the cut-out image.

17. A non-transitory computer-readable recording medium that records a program for causing a computer to execute:
acquiring a synthetic aperture radar (SAR) image;
detecting an object included in the SAR image;
determining a size of a cut-out image corresponding to the object; and
generating the cut-out image obtained by cutting out an image having the determined size from the SAR image in such a way that a position of the object in the cut-out image is random.

18. The recording medium, according to claim 17, that records the program for causing the computer to further execute:
generating the cut-out image in such a way that the position of the object in the cut-out image is random to such an extent that the position of the object is not learned as one of feature amounts.

19. The recording medium, according to claim 17, that records the program for causing the computer to further execute:
randomly determining a position of a reference point in a detection range in which the object is detected in the cut-out image.

20. The recording medium, according to claim 17, that records the program for causing the computer to further execute:
generating the cut-out image in such a way that the entire detection range in which the object is detected is included in the cut-out image.
